(19) United States
(12) Patent Application Publication
(10) Pub. No.: US 2023/0279252 A1
(43) Pub. Date: Sep. 7, 2023

(54) STABLE LIQUID CROSSLINKER COMPOSITIONS FOR HEAT-CURABLE INKS

(71) Applicant: INX International Ink Co., Schaumburg, IL (US)

(72) Inventors: Charles Arthur Billstrand, Lansing, IL (US); Alexander Folloso, Elgin, IL (US)

(21) Appl. No.: 17/686,044

(22) Filed: Mar. 3, 2022

(51) Int. Cl. C09D 11/38; C09D 11/104; C08K 5/3492; C09D 11/037; C09D 11/033; B41J 11/00; B41M 5/00

(52) U.S. Cl. CPC C09D 11/38; C09D 11/104; C08K 5/3492; C09D 11/037; C09D 11/033; B41J 11/002; B41M 5/0058

(57) ABSTRACT

The present disclosure provides an ink vehicle composition comprising a crosslinker compound of formula (I); a hydroxy functional polymer; and a nonvolatile diluent, wherein the composition is essentially free of butanol. Also provided are thermoset heat-curable inks including the ink vehicle composition and a method of printing onto a surface of a substrate by applying the thermoset heat-curable ink. The ink vehicle composition and the thermoset heat-curable ink herein may be stable for about 6 to about 24 months at room temperature.

### FIELD

This disclosure relates to stable compositions containing 1,3,5-triazine carbamates (TACT) crosslinkers for use in, e.g., high-speed offset printing of heat-curable inks and processes for preparing the same.

### BACKGROUND

TACT compounds are trifunctional melamine based crosslinkers containing a reactive carbamate functionality. TACT crosslinkers are solid materials that require dissolution in a solvent. TACT crosslinkers are not soluble in polyether glycol type solvents, and commercial TACT crosslinkers are typically supplied as a 50-52% solution in n-butanol. However, due to the boiling point of butanol, the butanol solution of TACT does not allow proper printing characteristics for use in high-speed offset printing of thermoset (heat-curable) ink formulations. In addition, the solid crosslinker may precipitate from the ink during storage due to butanol evaporation, thus interfering with the printing process.

To date, the use of TACT crosslinkers in heat-curable, high-speed offset printable inks (such as those useful for printed images on a metal surface) remains a technical challenge. TACT is not soluble by itself in typical ink diluents due to its solubility parameter. Therefore, there remains a need for stable TACT crosslinker compositions for use in heat-curable, high-speed offset printing inks, desirably with comparable or better printing performance than existing formulations that do not use TACT as a curing agent.

### SUMMARY

In one aspect, disclosed are ink vehicle compositions including a crosslinker compound of formula (I),

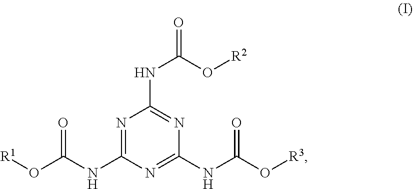

wherein R¹, R², and R³ are each independently a C₁₋₁₀alkyl; a hydroxy functional polymer; and a nonvolatile diluent, wherein the composition is essentially free of butanol.

In another aspect, disclosed are methods of preparing an ink vehicle composition, the method including mixing a crosslinker compound of formula (I),

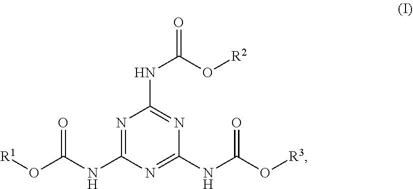

wherein R¹, R², and R³ are each independently a C₁₋₁₀alkyl and wherein the crosslinker compound is dissolved in butanol, a hydroxy functional polymer, and a nonvolatile diluent to form a mixture; and evaporating at least 98% of the butanol from the mixture to provide a disclosed ink vehicle composition.

In another aspect, disclosed are thermoset heat-curable inks including (a) a disclosed ink vehicle composition; and (b) a colorant.

In another aspect, disclosed are methods of printing an ink onto a substrate, the method including: applying a disclosed thermoset heat-curable ink on a surface of a substrate; and heating the applied thermoset heat-curable ink thereby curing the applied thermoset heat-curable ink.

### DETAILED DESCRIPTION

The present disclosure provides liquid crosslinker compositions containing TACT crosslinker compounds. The liquid crosslinker compositions are particularly suited for use in preparing curable compositions such as high solids coating compositions, over-print varnish, printable inks, and other related applications. And, the TACT crosslinker process does not emit or produce formaldehyde. For heat-curable inks, the TACT crosslinker may be mixed with a hydroxy functional polymer and a nonvolatile diluent to form a heat-curable composition, which may be used as an ink vehicle composition for the preparation of a printable ink. The crosslinker compositions and inks described herein may remain stable for extended periods of time at room temperature, without crosslinking, solid precipitation, or stratification of components. Thus, the present disclosure provides formaldehyde-free, heat-curable, printable inks, which may be useful for printing images on a hard surface, such as a metal surface of a container.

### 1. DEFINITIONS

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “an” and “the” include plural references unless the context clearly dictates otherwise. The present disclosure also contemplates other embodiments “comprising,” “consisting of” and “consisting essentially of,” the embodiments or elements presented herein, whether explicitly set forth or not.

The modifier “about” used in connection with a quantity is inclusive of the stated value and has the meaning dictated by the context (for example, it includes at least the degree of error associated with the measurement of the particular quantity). The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

The term “alkyl” as used herein, means a straight or branched, saturated hydrocarbon chain containing from 1 to 20 carbon atoms. The term “lower alkyl” or “C₁₋₆alkyl” means a straight or branched chain hydrocarbon containing from 1 to 6 carbon atoms. Representative examples of alkyl include, but are not limited to, methyl, ethyl, n-propyl, iso-propyl, n-butyl, sec-butyl, iso-butyl, tert-butyl, n-pentyl, isopentyl, neopentyl, n-hexyl, 3-methylhexyl, 2,2-dimethylpentyl, 2,3-dimethylpentyl, n-heptyl, n-octyl, n-nonyl, and n-decyl.

In some instances, the number of carbon atoms in an alkyl is indicated by the prefix “C_{x-y}” or “Cₓ-C_{y}-”, wherein x is the minimum and y is the maximum number of carbon atoms in the substituent. Thus, for example, “C₁₋₄alkyl” or “C₁-C₄-alkyl” refers to an alkyl substituent containing from 1 to 4 carbon atoms.

The term “butanol” means n-butanol, having a formula of CH₃(CH₂)₃OH.

The term, “cure” or “curing” means a process that leads to hardening and/or crosslinking of the hydroxy functional polymer with other hydroxy functional polymers, within the same polymer, or a combination thereof. In addition, the nonvolatile diluent may also interact with the crosslinker depending on whether the nonvolatile diluent has a functional group that can react with the crosslinker compound. Curing can be initiated by heat.

The term “essentially free” means a component is absent in a composition or is present in the composition in an amount of 2% or less by weight of the composition, including 1% or less, 0.5% or less, 0.01% or less, 0.005% or less, or 0.001% or less by weight.

The terms “hydroxy” and “hydroxyl” are used interchangeably herein and mean an — OH group.

The term “molecular weight” means number average molecular weight unless expressly noted otherwise. Molecular weight can be measured by standard techniques known within the art, such as gel permeation chromatography, size exclusion chromatography, and or rheological analysis.

The terms “nonvolatile” and “volatile,” as it relates to the components of the ink vehicle composition and/or ink, refer to the percentage of a component (e.g., nonvolatile diluent) released from an ink vehicle composition and/or ink under specified bake conditions as described in ASTM D2369-20. For example, “volatile” refers to a component substantially vaporizing (e.g., greater than 90%, greater than 95%, greater than 99%, or about 100%) from the ink vehicle composition and/or ink when heated at 110±5° C. for 60 minutes. “Nonvolatile” refers to a component not substantially vaporizing (e.g., less than 10%, less than 5%, less than 1%, or about 0%) from the ink vehicle composition and/or ink when heated at 110±5° C. for 60 minutes.

The term “oligomer” refers to a material having a molecular weight of about 1,000 g/mole to 3,000 g/mole.

The term “polymer” refers to a macromolecule that has a molecular structure including a large number of smaller units bonded together. The smaller units are generally coming from monomers or oligomers. The term is used interchangeably with resin herein.

The term “room temperature” means a temperature of about 20° C. to about 25° C.

### 2. INK VEHICLE COMPOSITIONS

In one aspect, the present disclosure provides an ink vehicle composition comprising a crosslinker compound of formula (I),

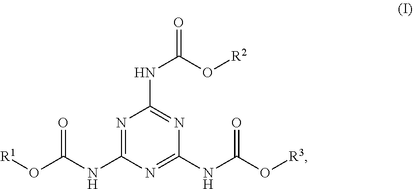

wherein R¹, R², and R³ are each independently a C₁₀alkyl;

a hydroxy functional polymer; and

a nonvolatile diluent,

wherein the composition is essentially free of butanol.

In some embodiments, R¹, R², and R³ are each independently a C₁₋₄alkyl. In some embodiments, R¹, R², and R³ are each independently n-butyl (—CH₂CH₂CH₂CH₃) or methyl (—CH₃). TACT based crosslinker compounds are commercially available and are typically supplied in n-butanol as a solvent. The n-butanol and any other co-solvent that is volatile can be replaced with nonvolatile diluent through an appropriate solvent exchange.

The crosslinker compound may also be referred to herein as a 1,3,5-triazine carbamate (TACT) crosslinker. The TACT crosslinker can be used to crosslink polymers containing hydroxy, epoxy, thiol, amino, and/or carboxy functionalities. For example, the TACT crosslinker can react with hydroxy groups of the hydroxy functional polymer at >125° C. to form urethane linkages. The TACT-based crosslinking process does not produce or emit formaldehyde. Accordingly, the disclosed ink vehicle compositions can be free of formaldehyde. In some embodiments, the ink vehicle composition is free or essentially free of formaldehyde.

The crosslinker compound can be employed as the sole crosslinker in the ink vehicle composition, or it may be used in combination with other crosslinkers, such as amino resins or isocyanates. Other crosslinkers may be used in order to obtain a balance of properties. In some embodiments, the ink vehicle composition does not contain any other crosslinkers outside of the crosslinker compound.

The ink vehicle composition may comprise about 10% to about 90% by weight the crosslinker compound, such as about 20% to about 80% by weight or about 25% to about 70% by weight.

The hydroxy functional polymers as described herein are polymers containing a plurality of hydroxy groups. For example, the hydroxy functional polymer can include at least two, and, preferably, more than two hydroxy groups. The hydroxy groups may be pendent from the backbone of the polymer, or may be at the terminals of the polymer, or both. The hydroxy functional polymers may be modified by one or more fatty acids. Suitable hydroxy functional polymers include, for example, polyacrylic, polyester, polyurethane, and alkyd materials. Suitable hydroxy functional polyacrylic polymers may be obtained, for example, by the copolymerization of acrylic or methacrylic esters with hydroxy functional acrylic or methacrylic esters, such as hydroxyethyl acrylate or methacrylate. Suitable hydroxy functional polyesters may be obtained, for example, by the reaction of polycarboxylic acids with excess quantities of polyhydric alcohols. In some embodiments, the hydroxy functional polymer is a hydroxy functional polyester, a hydroxy functional polyacrylic, a hydroxy functional polyurethane, or a combination thereof. In some embodiments, the hydroxy functional polymer is a hydroxy functional polyester or a hydroxy functional polyacrylic.

The hydroxy functional polymer may have a molecular weight and hydroxyl number that makes it suitable for use in ink formulations, such as thermosetting, heat-curable inks. For example, the hydroxy functional polymers may have a weight average molecular weight (Mw) of about 1000 g/mole to about 6000 g/mole, and number average molecular weight (Mn) from about 500 g/mole to about 3000 g/mole. In addition, the hydroxy functional polymers may have hydroxyl numbers of about 30 to about 300 mg KOH/g polymer. The hydroxy functional polymers may also have acid numbers of about 10 to about 100 mg KOH/g polymer.

Examples of hydroxy functional polymers include JONCRYL® 540 acrylic resin polymer (S.C. Johnson & Sons, Racine, Wis.), JONCRYL® 500 acrylic resin (S.C. Johnson & Sons, Racine, Wis.), ACRYLOI DO AT-400 acrylic resin (Rohm & Haas, Philadelphia, Pa.), CYPLEX® 1531 polyester resin (Cytec Industries, West Paterson, N.J.), CARGILL 3000 and 5776 polyester resins (Cargill, Minneapolis, Minn.), TONE® polyester resin (Union Carbide, Danbury, Conn.), K-FLEX® XM-2302 and XM-2306 resins (King Industries, Norwalk, Conn.), CHEMPOL® 11-1369 resin (Cook Composites and Polymers (Port Washington, Wis.), RHOPLEX®AC-1024 acrylic emulsion resin (Rohm & Haas, Philadelphia, Pa.), XC® 4005 water reducible acrylic resin (Cytec Industries, West Paterson, N.J.), CRYLCOAT® 3494 solid hydroxy terminated polyester resin (UCB CHEMICALS USA, Smyrna, Ga.), RUCOTE® 101 polyester resin (Ruco Polymer, Hicksville, N.Y.), JONCRYL® SCX-800-A and SCX800-B hydroxy functional solid acrylic resins (S.C. Johnson & Sons, Racine, Wis.), ALFTALAT® AN 745 hydroxy functional polyester resin, a product of Hoechst Corporation, and the like.

In some embodiments, the hydroxy functional polymer is a hydroxy functional polyester (also referred to as a polyester polyol). Suitable polyester polyols include, for example, a tridecyl ester polymer prepared from 1,3-benzenedicarboxylic acid, 1,3-dihydro-1,3-dioxo-5-isobenzofurancarboxylic acid, and 2,2-dimethyl-1,3-propanediol.

In some embodiments, the hydroxy functional polymer is a hydroxy functional polyacrylic. An example hydroxy functional polyacrylic is JONCRYL® 500, which has the following properties.

| Property | Value & Unit | |
|---|---|---|
| VOC Range (formulated) | 2.3-2.8 | lbs/gal |
| Solids content | 80% | wt |
| Glass transition temperature (Tg) | −7° | C. |
| Equivalent weight (—OH on solids) | 400 | |
| Hydroxyl number (on solids) | 140 | |
| Density | 1.03 | g/cm³ |
| Melting point | −35° | C. |
| Boiling point | 152° | C. |
| Vapour pressure | 3.86 | mmHg |
| Viscosity | 3900 | cps |

The ink vehicle composition may comprise about 20% to about 80% by weight the hydroxy functional polymer, such as about 30% to about 70% by weight or about 40% to about 60% by weight.

The nonvolatile diluent is an oligomer and is nonvolatile as defined by D2369-20 and herein. Because the nonvolatile diluent is an oligomer, it has a lower molecular weight compared to the hydroxy functional polymer. The nonvolatile diluent may be a hydrocarbon, a glycol, an alkylated polyglycol, a polyester, a fatty alcohol, or a combination thereof. The nonvolatile diluent can allow for high-speed offset printing with little to no evaporation. For example, the nonvolatile diluent can have a boiling point of at least 145° C., such as at least 150° C., at least 160° C., or at least 170° C. In some embodiments, the nonvolatile diluent has a boiling point of about 145° C. to about 200° C., such as about 145° C. to about 190° C. or about 150° C. to about 185° C. Accordingly, the nonvolatile diluent does not readily evaporate into a gas at room temperature or up to temperatures that are used for thermal ink curing.

As mentioned above, the crosslinker compound may be provided in a solvent. In these embodiments, the nonvolatile diluent may be exchanged with the solvent and may have a boiling point of at least 30° C. higher than the boiling point of the solvent being exchanged, such as at least 40° C. higher than the boiling point of the solvent being exchanged, at least 50° C. higher than the boiling point of the solvent being exchanged, or at least 60° C. higher than the boiling point of the solvent being exchanged.

During the curing process, the nonvolatile diluent may or may not participate in the crosslinking reaction. Whether the nonvolatile diluent participates in the crosslinking reaction depends on whether the nonvolatile diluent has functional groups that can react with the crosslinker compound. In some embodiments, the nonvolatile diluent reacts with the crosslinker compound during curing. For example, the nonvolatile diluent may have hydroxy, epoxy, thiol, amino, and/or carboxy functionalities. In some embodiments, the nonvolatile diluent has at least one hydroxy functional group. In other embodiments, the nonvolatile diluent does not react with the crosslinker compound during curing.

Suitable nonvolatile diluents include commercially available polyalkanol amines (Eastman), glycols and polyglycols (BASF, Dow), and fatty alcohols (such as tridecanol). In some embodiments, the nonvolatile diluent is a polyalkylene glycol. Polyalkylene glycols can be synthesized through a ring-opening reaction of alkylene oxides, such as ethylene oxide and propylene oxide, with an alcohol, such as glycols. The polyalkylene glycol may be of one type of monomer or may include two or more monomers. In addition, the polyalkylene glycol may be alkylated. In some embodiments, the polyalkylene glycol is polyethylene oxide, polypropylene oxide, butoxy-(polyethylene oxide-polypropylene oxide) mixture, or a combination thereof. In some embodiments, the nonvolatile diluent is a polyalkylene glycol, butoxy-(polyethylene oxide-polypropylene oxide) mixture, or a combination thereof.

The ink vehicle composition may comprise about 5% to about 30% by weight the nonvolatile diluent, such as about 5% to about 20% by weight or about 10% to about 20% by weight.

In some embodiments, the ink vehicle composition may comprise about 10% to about 30% by weight the crosslinker compound, about 40% to about 80% by weight the hydroxy functional polymer, and about 5% to about 20% by weight the nonvolatile diluent. An example composition is shown below.

| | Weight % |
|---|---|
| hydroxy functional polymer | 49.5% |
| nonvolatile diluent | 35% |
| crosslinker compound | 15.5% |
| Total | 100% |

In some embodiments, the composition comprises a crosslinker compound of formula (I), wherein R¹, R², and R³ are each independently methyl or n-butyl, a hydroxy functional polyester as a hydroxy functional polymer, and a polyalkylene glycol as a nonvolatile diluent.

As mentioned above, butanol is not compatible with ink formulations that are heat curable. Accordingly, because the disclosed ink vehicle compositions can be used for heat curable ink compositions, they can include little to no butanol. For example, the ink vehicle composition may comprise 2% or less by weight butanol, such as 1% or less, 0.5% or less, 0.1% or less, 0.05% or less, 0.01% or less, 0.005% or less, or 0.001% or less by weight. In some embodiments, the ink vehicle composition comprises 0.1% or less by weight butanol. In some embodiments, the ink vehicle composition is essentially free of butanol. In some embodiments, the ink vehicle composition is free of butanol.

In addition, the ink vehicle composition may be essentially free of other volatile solvents, including water and organic solvents such as hydrocarbon, alcohol, ketone, ether, ester, and amide solvents known in the art. In some embodiments, the composition is free of any volatile solvents.

The ink vehicle composition may have properties that make it suitable for ink formulations. For example, the ink vehicle composition may be a liquid. In addition, the ink vehicle composition may have a viscosity of about 200 to about 500 Poise, such as about 250 to about 350 Poise. The ink vehicle composition may also have a density of about 8 pound/gallon to about 12 pound/gallon, such as about 9, about 9.5, about 10, or about 11 pound/gallon. In some embodiments, the composition may have a density of about 9.3 pound/gallon.

The ink vehicle composition may be in the form of a clear liquid. The ink vehicle composition may have a Refractive Index of 1.2 or greater, such as 1.3 or greater, 1.4 or greater, 1.5 or greater, or 1.6 or greater. In some embodiments, the composition has a Refractive Index of 1.496 or greater.

The combination of the crosslinker compound, hydroxy functional polymer, and the nonvolatile diluent can instill advantageous stability properties to the ink vehicle composition and inks thereof. For example, the ink vehicle composition may be stable for at least 6 months at room temperature, including at least 12 months, at least 18 months, or at least 24 months. In some embodiments, the ink vehicle composition is stable for about 6 to about 24 months at room temperature. As described herein, an ink vehicle composition is considered stable for a period of time if no observable changes in its physical appearance or chemical nature occur during that period. Such changes include, for example, decomposition of a component, reaction between different components, precipitation of a solid substance, stratification of components, or change of color. Stability of the ink vehicle compositions can be measured or assessed via observing composition rheology over time with storage conditions ranging from room-temp to hot-box to freeze-thaw; see, e.g., ASTM D1849, ASTM D2337. For example stability can be shown through no change in viscosity or rheology when maintained at 60° C. or −20° C. upon return to room temperature and no formation of gel particles.

### a. Methods of Making the Ink Vehicle Compositions

The ink vehicle composition may be prepared by a method comprising mixing the crosslinker compound dissolved in butanol, the hydroxy functional polymer, and the nonvolatile diluent to form a mixture, and evaporating at least 98% of the butanol from the mixture to provide the disclosed ink vehicle composition.

The evaporation may be carried out by heating the mixture under reduced pressure, such as 20 mmHg (torr) or less, 10 mmHg or less, or 5 mmHg or less. The evaporation may be carried out at a temperature of about 55° C. to about 75° C., such as about 60° C., about 65° C., or about 70° C. In some embodiments, the evaporation is carried out by heating the mixture at about 60° C. to about 75° C. under a pressure of 20 mmHg or less.

The remaining amount of butanol in the ink vehicle composition after the evaporating step may be 2% or less of the amount of butanol before the evaporation, including 1.5% or less, 1.0% or less, 0.5% or less, 0.1% or less, 0.05% or less, or 0.01% or less.

### 3. THERMOSET HEAT-CURABLE INKS

In another aspect, the present disclosure provides a thermoset heat-curable ink, which comprises (a) an ink vehicle composition as described herein and (b) a colorant.

The colorant may be a pigment or dye. The colorant may be a self-dispersing material or it may be used in combination with a separate dispersant. In some embodiments, the colorant is a pigment. In general, any pigment can be employed that is compatible with the other components of the ink and is heat stable at the requisite curing temperatures. The pigment may be cyan, magenta, yellow, black, white, red, orange, violet, blue, green, brown, or a mixture thereof. Examples of the pigments can be grouped in the corresponding color index:

Pigment Yellow 1, 3, 5, 12, 13, 14, 15, 17, 34, 35, 37,41, 42, 43, 55, 74, 81, 83, 87,93, 94, 95, 97, 108, 109, 110, 117, 119, 138, 139, 153, 154, 155, 157, 166, 167, 168, 174, 175, 180, 185, 193, 213, 214, and 215;

Pigment Red 3, 5, 19, 22, 23, 31, 38, 41, 43, 48:1, 48:2, 48: 3, 48:4, 48:5, 49:1, 52, 52:1, 52:2, 53:1, 57:1, 57:2, 58:4, 63:1, 64:1, 81, 81:1, 81:2, 81:3, 81:4, 88, 95,104, 108, 112, 122, 123, 136, 144, 146, 149, 166, 168, 169, 170, 175, 177, 178, 179, 184, 185, 208, 216, 226, 254, 257, and 279;

Pigment Blue 1, 15, 15:1, 15:2, 15:3, 15:4, 15:6, 16, 17:1, 22, 24, 24:1, 27, 28, 29, 36, 60, 61, 62, 63, and 75;

Pigment Black 7, 9, 10, 28, and 34;

Pigment White 6, 11, 12, 18, 21, and 22;

Pigment Orange 4, 5, 13, 16, 20, 34, 36, and 64;

Pigment Violet 1, 2, 3, 19, 23, 25, 27, 29, 30, 37, and 50;

Pigment Green 7, 8, 10, 17, 26, and 36; and

Pigment Brown 3, 5, 25, and 26.

The thermoset heat-curable ink may comprise about 0.1% to about 60% by weight the ink vehicle composition, such as about 30% to about 60% by weight or about 40% to about 60% by weight. In addition, the thermoset heat-curable ink may comprise about 0.1% to about 50% by weight colorant, such as about 10% to about 60% by weight or about 20% to about 60% by weight.

The thermoset heat-curable ink may further comprise a lubricant, a viscosity modifier, a tack modifier, a flow modifier, a surfactant, a diluent, or a combination thereof. The thermoset heat-curable ink may comprise about 0% to about 5% by weight tack modifier. Suitable tack modifiers include, for example, talc, clay, silica, or a combination thereof. The thermoset heat-curable ink may comprise about 0% to about 5% by weight surfactant. Suitable surfactants include, for example, alkoxylated surfactants. The thermoset heat-curable ink may comprise about 0% to about 20% by weight viscosity modifier. The thermoset heat-curable ink may comprise about 0% to about 5% by weight flow modifier. Suitable viscosity modifiers and flow modifiers are known in the art.

The thermoset heat-curable ink may be prepared by mixing the ink vehicle composition as described herein, the colorant, and any other ingredients. Typically, the ink vehicle composition is measured into a mixing tank. The colorant is then added and dispersed. Diluent and other ingredients may be further added to adjust viscosity to a desired level.

Representative thermoset heat-curable inks prepared by the method as described herein may be used for printing on any surface that can withstand the temperatures needed to cure the thermoset heat-curable ink. An example surface includes a metal surface (such as an aluminum surface). Example thermoset heat-curable inks can display the following physical properties:

Tack, 1′, 90° F. (32.2° C.) ©1200rpm:
8.0−21.0±1 (Ink)
14.0−25.0±1 (Base);

Grind:
<3 NPIRI
<7.5 microns; and

Laray Viscosity, 25° C.:
50+/−20 poise.

The thermoset heat-curable inks as described herein may be stable for at least 6 moths at room temperature, including at least 12 months, at least 18 months, or at least 24 months. In some embodiments, the thermoset heat-curable ink is stable for about 6 to about 24 months at room temperature. The thermoset heat-curable inks may maintain no to low discoloration induced by heat or air oxidation. Crosslinking reactions may not occur in the present inks until sufficient activation energy is imparted during cure cycle (e.g., in baking enamel ovens). The present inks can avoid pigment sedimentation during storage or use.

### 4. PRINTING

In another aspect, the present disclosure provides a method of printing an ink onto a substrate, comprising applying the thermoset heat-curable ink as described herein on a surface of a substrate, and heating the applied ink thereby curing the applied ink. Curing can typically be accomplished without use of a catalyst. In addition, the cured films and/or inks can exhibit useful hardness, chemical resistance, exterior durability, and environmental etch resistance.

The heating may be carried out at a temperature of at least 150° C., including at least 170° C., at least 190° C., or at least 210° C. In some embodiments, the heating is carried out at about 180° C. to about 200° C., such as about 185° C., about 190° C., or about 195° C.

The substrate may be any substrate that can withstand the temperatures needed to cure the thermoset heat-curable ink. For example, the substrate can include a metal surface or is made of metal. Suitable substrates include containers for industrial or consumer goods, such as beverage or food containers. In some embodiments, the substrate is a metal container, such as an aluminum can for containing a beverage or a food.

In some embodiments, the present thermoset heat-curable inks are used in a high-speed offset printing process to provide printed images or decorations on a metal surface. Suitable processes include those performed under the applicable standards described by National Printing Ink Research Institute (NPI RI). Typical high speed offset printing process involves ink transferred from individual color (pigmented) ink wells to planographic plate that has ink receptive image areas. The process may be performed in a rotary system, and a thin metal plate may be wrapped around a cylinder. The inked image may be transferred from the plate to “the blanket”, an intermediate cylinder covered with a layer of rubber, which transfers the image to the substrate surface. For printing aluminum cans, the printing may proceed at high speeds of about 1000 to about 2000 cans per minute (cpm).

### 5. EXAMPLES

### Example 1—Preparation of Ink Vehicle Composition

TACT-based crosslinker solids of formula (I) where R¹, R², and R³ are each independently methyl or n-butyl in an approximately 50% by weight butanol mixture (15.5 parts by weight), polyester polyol (49.5 parts by weight), and polyalkylene glycol nonvolatile diluent (35 parts by weight) were mixed. At least 98% butanol was removed from the mixture by using rotary evaporation at 65° C. under a reduced pressure of about 20 torr.

The resulting composition was stored at room temperature for up to 2 years and no precipitation was observed.

### Example 2—Preparation of A Thermoset Heat-Curable Ink

A thermoset heat-curable ink was prepared according to the formulation:

| Ingredient | Wt % |
|---|---|
| Ink vehicle composition (Example 1) | 45.0 |
| Nonvolatile Diluent | 20.0 |
| Additive (viscosity modifier & flow modifier) | 3.0 |
| Red Pigment | 32.0 |
| Total | 100.0 |

### Example 3 —Printing on An Aluminum Can

The ink produced in Example 2 was printed onto aluminum cans by a high-speed Offset Print Process method, and the ink on the printed cans was cured in a baking oven at a temperature of 193° C. (380° F.).

For reasons of completeness, various aspects of the invention are set out in the following numbered clauses:

Clause 1. An ink vehicle composition comprising a crosslinker compound of formula (I),

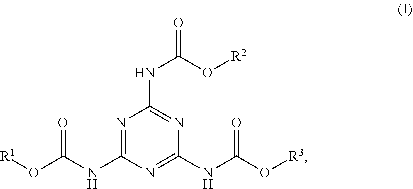

wherein R¹, R², and R³ are each independently a C₁₋₁₀alkyl; a hydroxy functional polymer; and a nonvolatile diluent, wherein the composition is essentially free of butanol.

Clause 2. The composition of clause 1, wherein R¹, R², and R³ are each independently a C₁₋₄ alkyl.

Clause 3. The composition of clause 1 or clause 2, wherein the crosslinker compound is in an amount of about 10% to about 90% by weight of the composition.

Clause 4. The composition of any one of clauses 1-3, wherein the hydroxy functional polymer is selected from the group consisting of a hydroxy functional polyester, a hydroxy functional polyacrylic, a hydroxy functional polyurethane, and a combination thereof.

Clause 5. The composition of any one of clauses 1-4, wherein the hydroxy functional polymer is in an amount of about 20% to about 80% by weight of the composition.

Clause 6. The composition of any one of clauses 1-5, wherein the nonvolatile diluent is selected from the group consisting of a hydrocarbon, a glycol, a polyalkylene glycol, a polyester, and a combination thereof.

Clause 7. The composition of any one of clauses 1-6, wherein the nonvolatile diluent is in an amount of about 5% to about 30% by weight of the composition.

Clause 8. The composition of any one of clauses 1-7, having a viscosity of about 200 to about 500 Poise.

Clause 9. The composition of any one of clauses 1-8, wherein the composition is stable for about 6 to about 24 months at room temperature.

Clause 10. The composition of any one of clauses 1-9, wherein R¹, R², and R³ are each independently methyl or n-butyl; the hydroxy functional polymer is a hydroxy functional polyester; and the nonvolatile diluent is polyalkylene polyglycol.

Clause 11. A method of preparing an ink vehicle composition, the method comprising: mixing a crosslinker compound of formula (I),

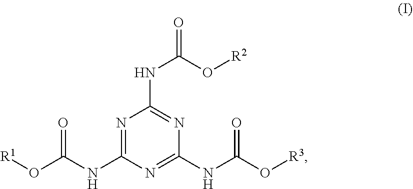

wherein R¹, R², and R³ are each independently a C₁₋₁₀alkyl and wherein the crosslinker compound is dissolved in butanol, a hydroxy functional polymer, and a nonvolatile diluent to form a mixture; and evaporating at least 98% of the butanol from the mixture to provide a composition as recited in any one of clauses 1-10.

Clause 12. The method of clause 11, wherein the evaporating comprises heating the mixture at a temperature of about 65° C. under a pressure of 20 mmHg (torr) or less.

Clause 13. A thermoset heat-curable ink, comprising (a) the ink vehicle composition of anyone of clauses 1-10; and (b) a colorant.

Clause 14. The thermoset heat-curable ink of clause 13, wherein the ink is stable for at least 6 months at room temperature.

Clause 15. The thermoset heat-curable ink of clause 13 or clause 14, wherein the ink vehicle composition is in an amount of about 30% to about 60% by weight of the ink.

Clause 16. The thermoset heat-curable ink of any one of clauses 13-15, wherein the colorant is in an amount of about 10% to about 60% by weight of the ink.

Clause 17. The thermoset heat-curable ink of any one of clauses 13-16, further comprising a lubricant, a viscosity modifier, a tack modifier, a flow modifier, a surfactant, a diluent, or a combination thereof.

Clause 18. A method of printing an ink onto a substrate, the method comprising: applying the thermoset heat-curable ink of any one of clauses 13-17 on a surface of a substrate; and heating the applied thermoset heat-curable ink thereby curing the applied thermoset heat-curable ink.

Clause 19. The method of clause 18, wherein the surface is a metal surface.

Clause 20. The method of clause 18 or clause 19, wherein the substrate is a container.

Various features, advantages, and embodiments are set forth in the following claims.

What is claimed is:

1. An ink vehicle composition comprising
a crosslinker compound of formula (I), 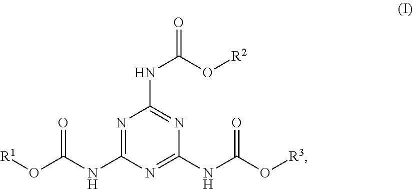
wherein R¹, R², and R³ are each independently a C₁₋₁₀alkyl;
a hydroxy functional polymer; and
a nonvolatile diluent,
wherein the composition is essentially free of butanol.

2. The composition of claim 1, wherein R¹, R², and R³ are each independently a C₁₋₄alkyl.

3. The composition of claim 1, wherein the crosslinker compound is in an amount of about 10% to about 90% by weight of the composition.

4. The composition of claim 1, wherein the hydroxy functional polymer is selected from the group consisting of a hydroxy functional polyester, a hydroxy functional polyacrylic, a hydroxy functional polyurethane, and a combination thereof.

5. The composition of claim 1, wherein the hydroxy functional polymer is in an amount of about 20% to about 80% by weight of the composition.

6. The composition of claim 1, wherein the nonvolatile diluent is selected from the group consisting of a hydrocarbon, a glycol, a polyalkylene glycol, a polyester, and a combination thereof.

7. The composition of claim 1, wherein the nonvolatile diluent is in an amount of about 5% to about 30% by weight of the composition.

8. The composition of claim 1, having a viscosity of about 200 to about 500 Poise.

9. The composition of claim 1, wherein the composition is stable for about 6 to about 24 months at room temperature.

10. The composition of claim 1, wherein
R¹, R², and R³ are each independently methyl or n-butyl;
the hydroxy functional polymer is a hydroxy functional polyester; and
the nonvolatile diluent is polyalkylene polyglycol.

11. A method of preparing an ink vehicle composition, the method comprising:
mixing a crosslinker compound of formula (I), 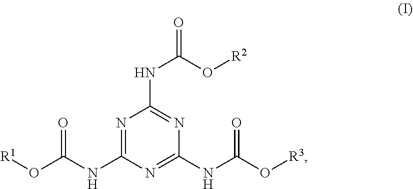
wherein R¹, R², and R³ are each independently a C₁₋₁₀alkyl and wherein the crosslinker compound is dissolved in butanol, a hydroxy functional polymer, and a nonvolatile diluent to form a mixture; and
evaporating at least 98% of the butanol from the mixture to provide a composition as claimed in claim 1.

12. The method of claim 11, wherein the evaporating comprises heating the mixture at a temperature of about 65° C. under a pressure of 20 mmHg (torr) or less.

13. A thermoset heat-curable ink, comprising
(a) the ink vehicle composition of claim 1; and
(b) a colorant.

14. The thermoset heat-curable ink of claim 13, wherein the ink is stable for at least 6 months at room temperature.

15. The thermoset heat-curable ink of claim 13, wherein the ink vehicle composition is in an amount of about 30% to about 60% by weight of the ink.

16. The thermoset heat-curable ink of claim 13, wherein the colorant is in an amount of about 10% to about 60% by weight of the ink.

17. The thermoset heat-curable ink of claim 13, further comprising a lubricant, a viscosity modifier, a tack modifier, a flow modifier, a surfactant, a diluent, or a combination thereof.

18. A method of printing an ink onto a substrate, the method comprising:
applying the thermoset heat-curable ink of claim 13 on a surface of a substrate; and
heating the applied thermoset heat-curable ink thereby curing the applied thermoset heat-curable ink.

19. The method of claim 18, wherein the surface is a metal surface.

20. The method of claim 18, wherein the substrate is a container.
